(19) United States
(12) Patent Application Publication
(10) Pub. No.: US 2018/0341680 A1
(43) Pub. Date: Nov. 29, 2018

(54) LOOSELY COUPLED SYSTEM

(71) Applicant: Bsquare Corp., Bellevue, WA (US)

(72) Inventor: David Wagstaff, Lake Forest, CA (US)

(21) Appl. No.: 15/900,288

(22) Filed: Feb. 20, 2018

Related U.S. Application Data
(60) Provisional application No. 62/511,540, filed on May 26, 2017.

(51) Int. Cl. G06F 17/30; G06Q 10/06; G06N 5/02

(52) U.S. Cl. CPC G06F 17/30477; G06N 5/02; G06Q 10/067

(57) ABSTRACT

A system and method decouple a knowledge management system from the consumer of the system. The system and method receives assertions from the consumer and utilizes a librarian to dynamically map these onto the proper data management components, either a researcher, a consultant or a historian. The librarian may rely on an arbiter to ensure that the proper data is received and returned.

### CROSS REFERENCE TO RELATED APPLICATIONS

This application claims the benefit of U.S. provisional patent application Ser. No. 62/511,540, filed on May 26, 2017, the contents of which are incorporated by reference herein in their entirety.

### BACKGROUND

Today the back end web services are tightly coupled to the consumer (UI, etc). Based on the question, the consumer generally knows what component is providing the answer. The front and back ends are “tightly coupled.” This is very rigid and does not allow for the adaptation of the system to incorporate more recent data. Often, when new data or new types of data are presented, the front or back end may be required to be rebuilt to accommodate that. This makes it difficult when data or requests come from third parties, as it requires complete knowledge to the data beforehand which is often impractical or impossible to accomplish.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a loosely-coupled system 100.

FIG. 2 illustrates an embodiment of a process for operating a loosely coupled system 200.

FIG. 3 an embodiment of a process for operating a loosely-coupled system 300.

FIG. 4 illustrates an embodiment of a loosely-coupled system 400.

FIG. 5 illustrates an embodiment of a loosely-coupled system 500.

FIG. 6 illustrates an embodiment of a loosely-coupled system 600.

FIG. 7 illustrates an embodiment of a loosely-coupled system 700.

FIG. 8 illustrates an aspect of an embodiment of a loosely-coupled system 800

FIG. 9 illustrates a system 900 in accordance with one embodiment.

### DETAILED DESCRIPTION

Business rules enable dynamic decisions at runtime allowing the automation of policies, computations, and reasoning while decoupling the rule logic from underlying application code. This allows for more agile rule maintenance and empowers business analysts with the ability to modify rule logic without programmer assistance and without interrupting business processes. Business rules may be statements that describe business policies or describe key business decisions.

For example, business rules may include:
Business policies such as spending policies and approval matrices.
Constraints such as valid configurations or regulatory requirements.
Computations such as discounts or premiums.
Reasoning capabilities such as offers based on customer value.

Business rules allow a business analyst to change policies that are expressed as business rules, with little or no assistance from a programmer.

A rule follows an if-then structure and consists of the following parts:

IF part: a condition or pattern match

Also called the ‘When’ or Left Hand-Side (LHS)

THEN part: a list of actions

Also called the ‘Consequence’ or Right Hand-Side (RHS)

Notice: No Else part

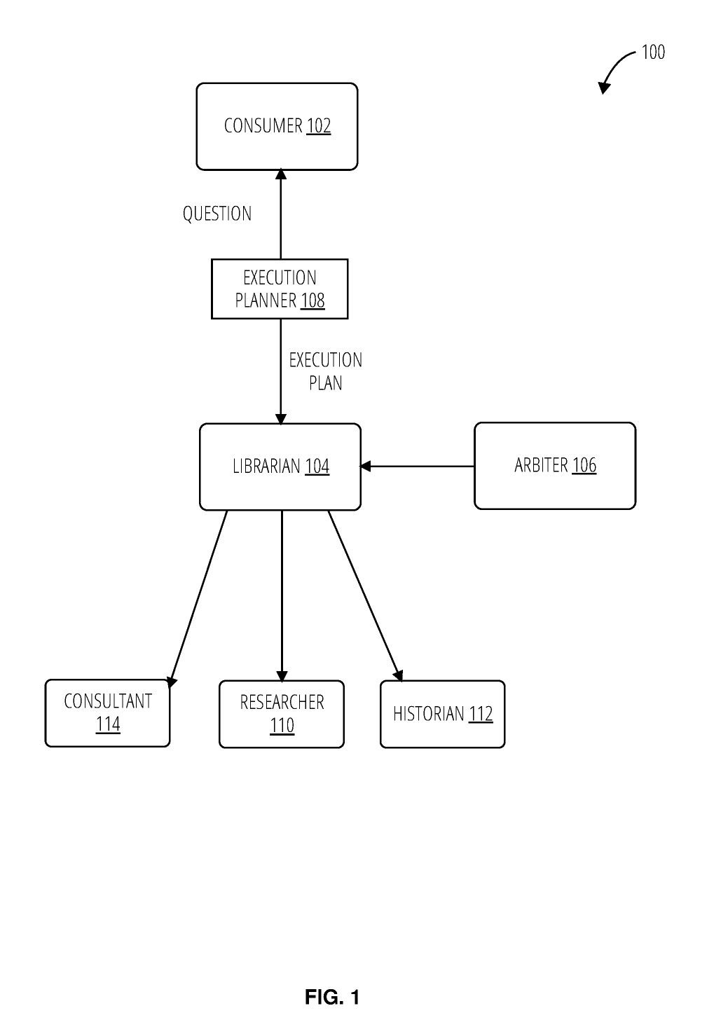

Referring to FIG. 1, a loosely-coupled system 100 comprises a consumer 102, a librarian 104, an arbiter 106, an execution planner 108, a researcher 110, a historian 112, and a consultant 114.

The consumer 102 may be a UI or a 3rd-party process, this asks a series of questions, for example “Is the truck going to fail?” The historian 112 may be a database, and may pull very simple queries from stored data. The researcher 110 may contain business logic. The consultant 114 may be vertical-specific knowledge built into the system, librarian 104 dynamically maps questions from the consumer 102 to the different back-end processes: the consultant 114, the historian 112, and the researcher 110. The librarian 104 contains data specifying which question types should be routed to each of the back-end components. By way of example, this data may be contained in a routing or hash table which may be routed based on the type and category of question. The arbiter 106 breaks possible ties with competing answers, and may decide which answer is the best one. The librarian may also recognize that there is a structured question, and request a mapping for different portions from the arbiter 106. The execution planner 108 may be domain-specific and may plan the execution of queries which may be executed by the librarian 104. There is a cost value or function which the arbiter 106 utilizes to find what the lowest cost, best quality data which can be returned. This allows for the just-in-time retrieval of facts (data), e.g. facts may be retrieved when at a time it is needed (when a rule is triggered) rule fires, instead of requiring massive data aggregation beforehand.

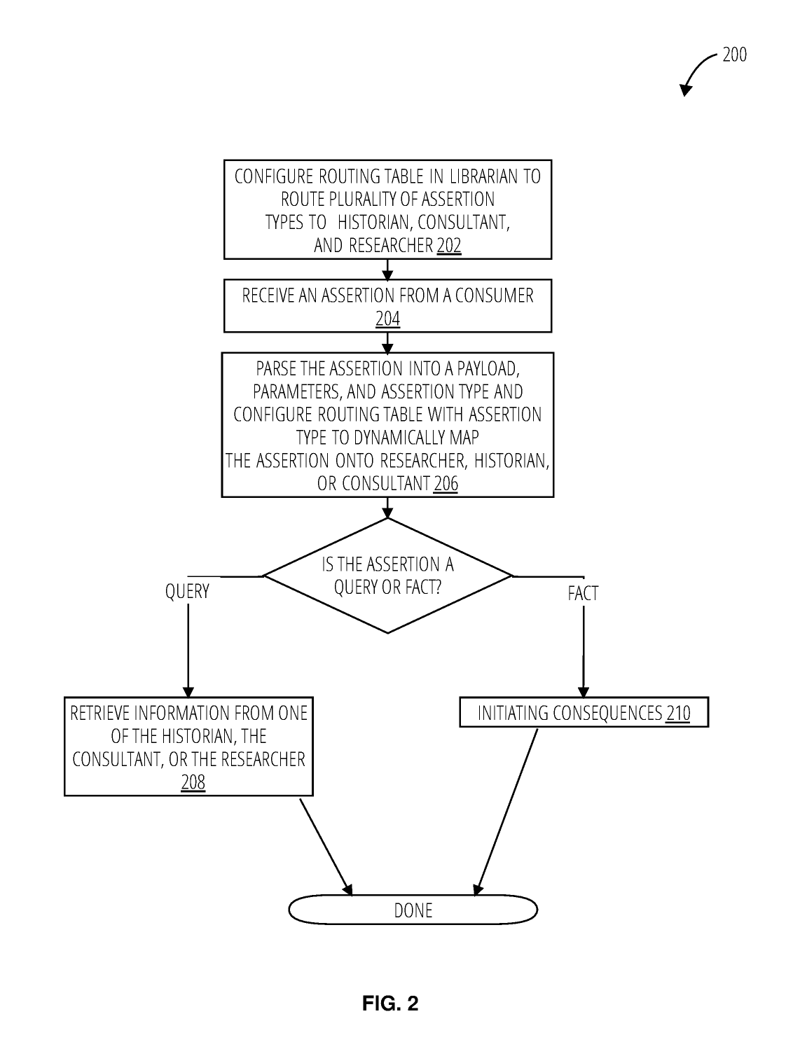

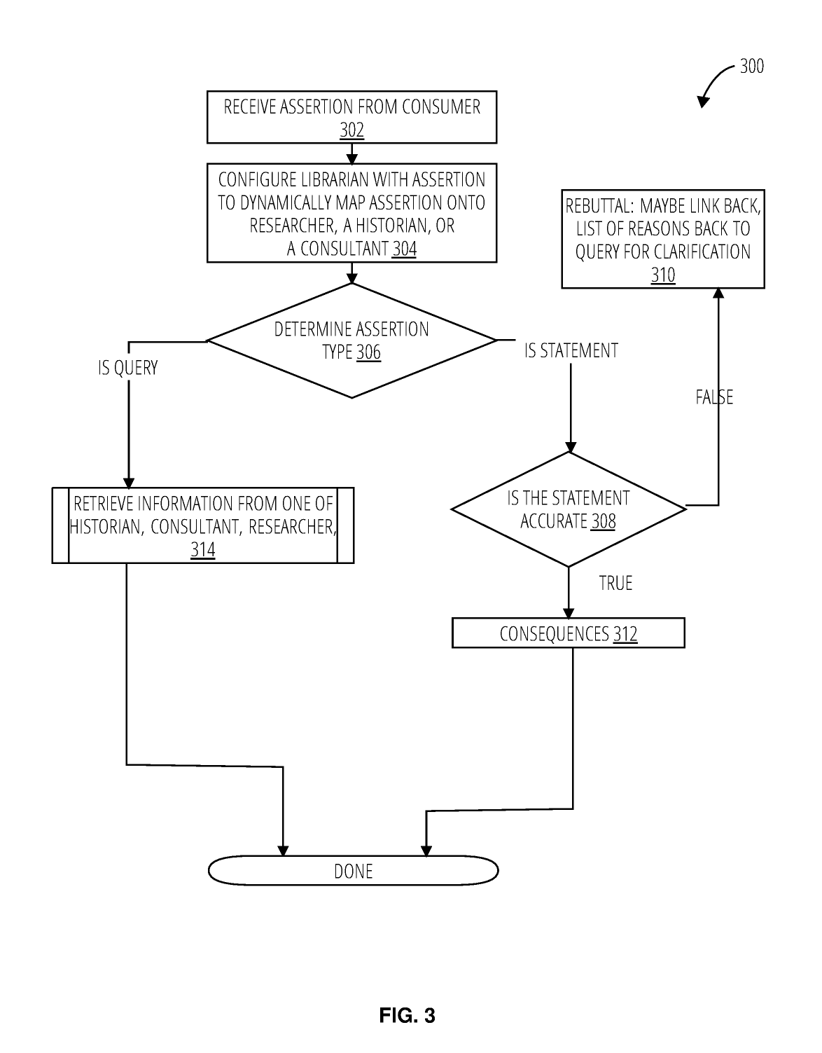

The loosely-coupled system 100 may be operated in accordance with the process for operating a loosely-coupled system 300 outlined in FIG. 2 and FIG. 3.

Referring to FIG. 2, the process for operating a loosely coupled system 200 configures a routing table in a librarian to route a plurality of assertion types to a historian, a consultant, and a researcher (block 202).

The process for operating a loosely coupled system 200 receives an assertion from a consumer (block 204).

The process for operating a loosely coupled system 200 parses the assertion into a payload, parameters, and assertion type and configures the routing table with the assertion type to dynamically map the assertion onto the researcher, the historian, or the consultant (block 206).

The process for operating a loosely coupled system 200 retrieves information from one of the historian, the consultant, or the researcher, if the assertion is a query (block 208).

The process for operating a loosely coupled system 200 initiates consequences (e.g., triggers a machine response) if the assertion is a “fact”—a condition not involving a data lookup (block 210).

A method may include configuring a routing table in a librarian to route a group of assertion types to a historian, a consultant, and a researcher. The method may receive an assertion from a consumer, parse the assertion into a payload, parameters, and assertion type and configure a routing table with the assertion type to dynamically map the assertion onto the historian, the consultant, or the researcher. The method may further retrieve information from one of the historian, the consultant, or the researcher, if the assertion is a query; and/or initiating consequences if the assertion is determined to be a fact.

Dynamically mapping the assertion may further include querying an arbiter to choose data sources based on cost. The consequences may further include persisting information to one of the historian, the consultant, or the researcher. The consequences may further include operating a machine-system. The researcher may contain translations to business logic. The consultant may be vertical-specific knowledge built into a system. In some embodiments, the historian may further include a control memory structure and may pull simple queries from stored data.

Referring to FIG. 3, the process for operating a loosely-coupled system 300 receives an assertion from a consumer. (block 302).

The process for operating a loosely-coupled system 300 configures a librarian with the assertion to dynamically map the assertion onto a researcher. (block 304)

The process for operating a loosely-coupled system 300 determines the assertion type. (decision block 306)

The process for operating a loosely-coupled system 300 initiates consequences based on truth of the statement. (block 312)

The process for operating a loosely-coupled system 300 retrieves information from one of the historian, consultant, researcher if the assertion is a query. (subroutine block 314)

A method may include receiving an assertion from a consumer and/or configuring a librarian with the assertion to dynamically map the assertion onto a researcher, a historian, or a consultant. Configuring a librarian with the assertion to dynamically map the assertion onto a researcher, a historian, or a consultant may include determining the assertion type. Retrieving information from one of the historian, the consultant, or the researcher, if the assertion is a query; and/or persisting information to one of the historian, the consultant, or the researcher, if the assertion is a fact. Dynamically mapping the assertion may further include querying an arbiter to choose data sources based on cost. The cost may be determined by a cost function which may be used to determine the expenditure of resources on a given task. For example, this may be the power consumption by the system, the system or network load at a given moment, or other expenditures of time or resources, or actual or projected monetary outlays due to these costs. By way of example, a user may need to know the current volume of fuel in a fuel tank, and may need to know it with close to 100% accuracy. This may require the system to retrieve the value from fuel tank sensors frequently, which may be very costly for the system and user temporally as well as monetarily. If the user does not need the to have very high-accuracy knowledge of the fuel volume, then the user may specify a lower priority and the system may retrieve the data less frequently, updating sensor readings only occasionally or during aberrant conditions. Costs may be normalized to allow the system to compare different types of costs based on importance, this may be, for example on a scale, from 0 to 1 or may be more qualitative, for example, “high, medium, low importance.” The researcher may contain translations to business logic. The assertion may further be a query or data.

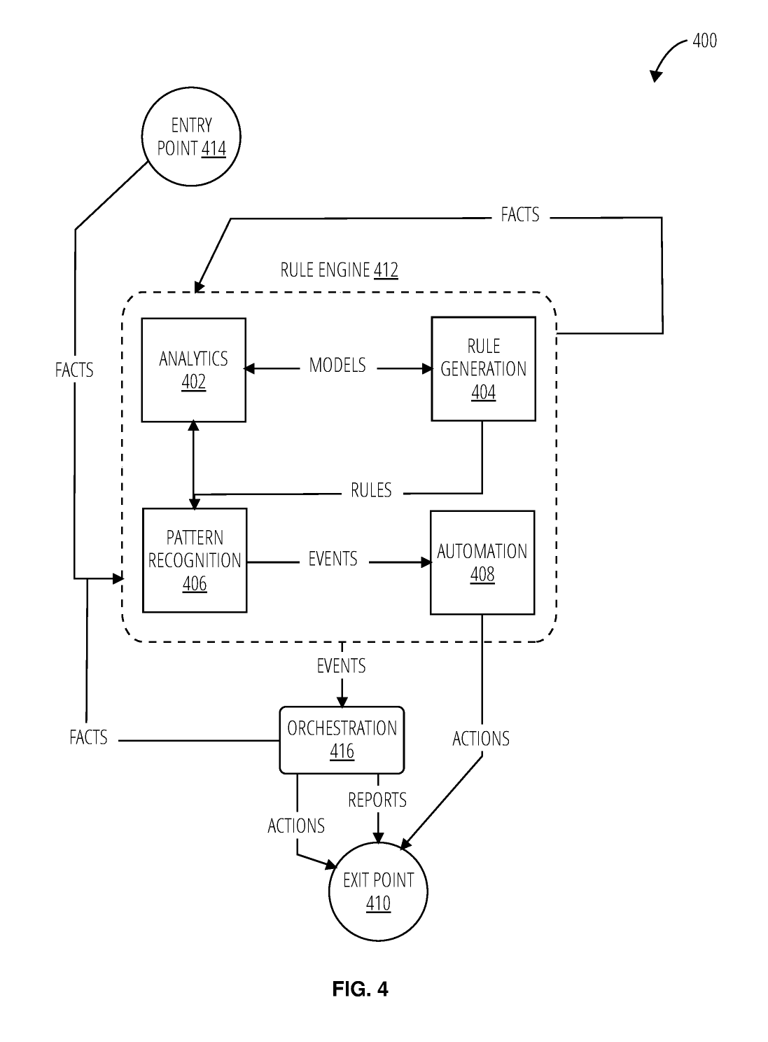

Referring to FIG. 4, the loosely-coupled system 400 comprises a rule engine 412, an entry point 414, an orchestration 416, and an exit point 410.

The entry point 414 may further comprise the librarian 104. The rule engine 412 further comprises analytics 402, rule generation 404, pattern recognition 406, and an automation 408.

Models may be passed between the analytics 402 and the rule generation 404. The rule generation 404 transmits rules to the pattern recognition 406, the pattern recognition 406 transmits events to the automation 408. The automation 408 passes actions to the exit point 410. The exit point 410, may further comprise the librarian 104, automation network, or some other type of system. Events may also be passed to the orchestration 416 which may, in turn, generate reports and actions based on the events. The rule engine 412 may assert new facts back to itself based on the output of the analytics 402, the rule generation 404, the pattern recognition 406 and the automation 408. A fact is immutable, and the rule engine may assert new facts. The orchestration may be what action is performed in response to the facts.

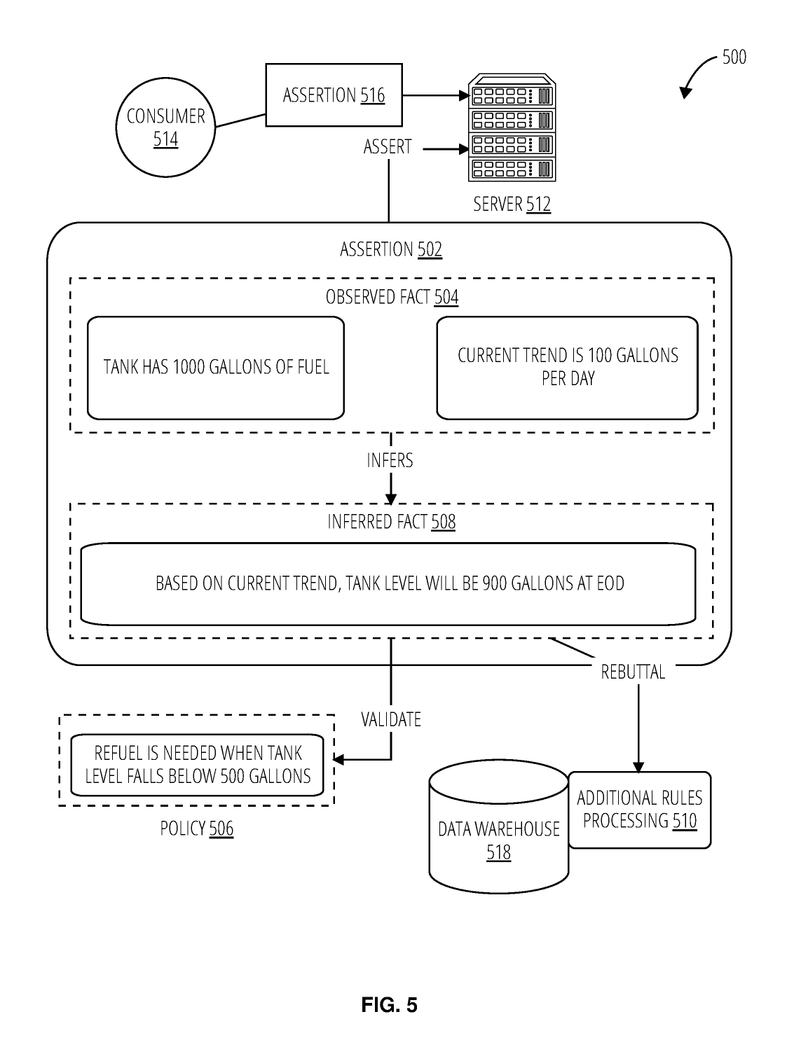

Referring to FIG. 5, the loosely-coupled system 500 comprises an observed fact 504, a policy 506, an inferred fact 508, additional rules processing 510, a server 512, a consumer 514, an assertion 516, and a data warehouse 518.

The observed fact 504 may comprise facts which have been directly observed or read from another source. The inferred fact 508 may comprise facts which are inferred from the existence of observed fact 504 facts.

When a sensor asserts a statement, a decision must be made to decide whether or not to retain the data. The sensors may be “dumb” relaying only data, with no knowledge of overall system context, so data retention decisions may be made by the rule engine 412. For example, the rule engine 412 may know, based on historical data, that the data should be persisted to nonvolatile memory only if it is a certain amount outside of a specified normal range.

The consumer 514 may make an assertion to the server 512, which contains the rule engine 412. The assertion made to the rule engine 412 may, for example, state that fuel needs to be delivered. The rule engine 412 may then read the observed fact 504 and infer the inferred fact 508 then validate the assertion 516 against the policy 506 in view of the inferred fact 508. The policy 506 may, for example, be a rule specified in a rule engine. This may contradict the assertion 516 in which case additional rules processing 510 must occur.

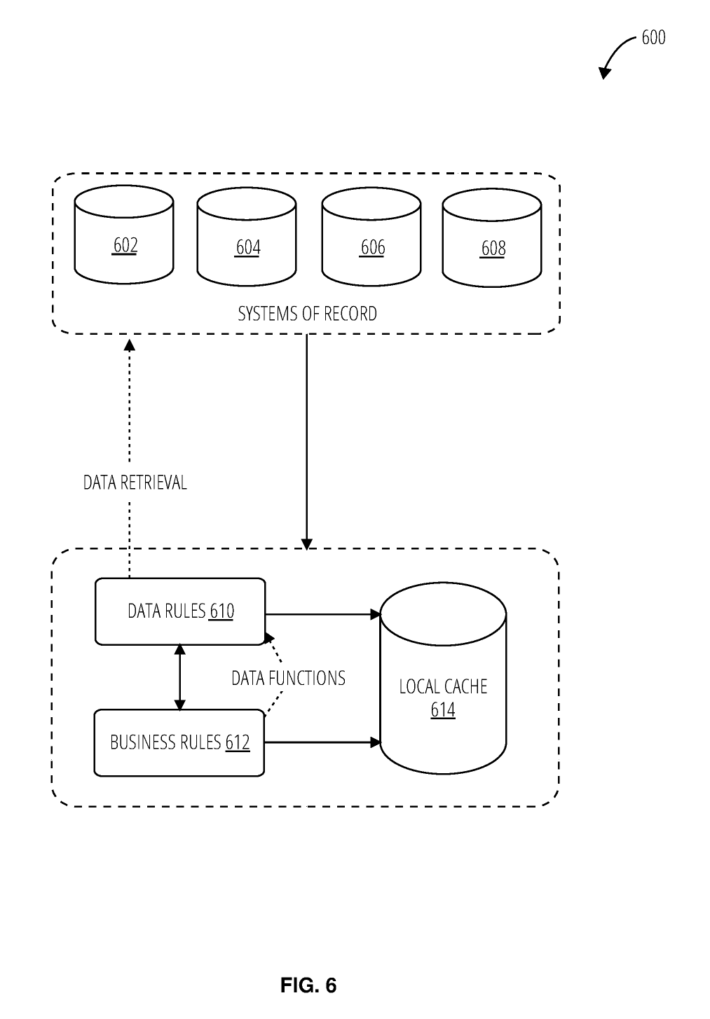

Referring to FIG. 6 the loosely-coupled system to prevent and manage knowledge 600 comprises a system of record 602, a system of record 604, a system of record 606, a system of record 608, a data rules 610, a business rules 612, and a local cache 614.

Rules engine intelligently only accesses data elements required to process logic and stores them in a local cache. This reduces load on source systems and enables efficient rule processing. After business logic processing is complete, local cache 614 is flushed. The data rules 610 may determine what data is retrieved and from which source and the business rules 612 may determine how that data may be used.

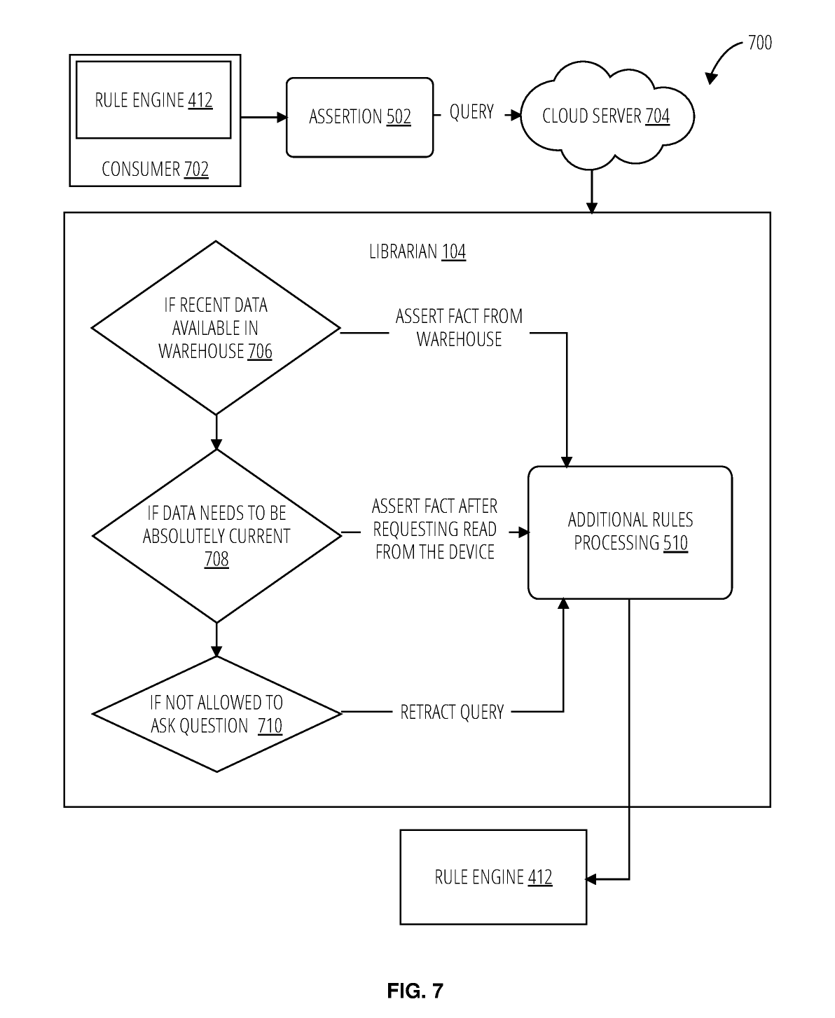

Referring to FIG. 7, the loosely-coupled system to loosely-coupled system 700 comprises a librarian 104, an assertion 502, additional rules processing 510, a consumer 702, a cloud server 704, a rule engine 412, and a rule engine 412. The consumer 702 may further comprise the rule engine 412. The librarian 104 further comprises the decision block 706, a decision block 710, and a decision block.

The consumer 702 makes an assertion 516 in the form of a query to the librarian 104 on the cloud server 704. The librarian 104 utilizes decision block 706, decision block 710, and decision block 708, to make a determination of where to map the requested data from, then sends the requested data back for additional rules processing 510, in the rule engine 412.

For example, if the current fuel consumption trend in the last hour is over forecasted trend by 500 gallons, the rule engine 412 may assert fact that the fuel tank will run out of fuel earlier than expected. The librarian 104 may look at the difference in the data and determine that there may be an issue, i.e., the tank may run out of gas early, so data needs to be absolutely current and therefore request the current status directly from the tank sensor, and then a fact may be asserted that the tank needs refueling, which may be incorporated into the additional rule processing in the rule engine 412.

For example, if the current fuel consumption trend in the last hour is over forecasted trend by 500 gallons, the rule engine 412 may assert fact that the fuel tank will run out of fuel earlier than expected. The librarian 104 may look at the difference in the data and determine that there may be an issue, i.e., the tank may run out of gas early, so data needs to be absolutely current and therefore request the current status directly from the tank sensor, and then a fact may be asserted that the tank needs refueling, which may be incorporated into the additional rule processing in the rule engine 412.

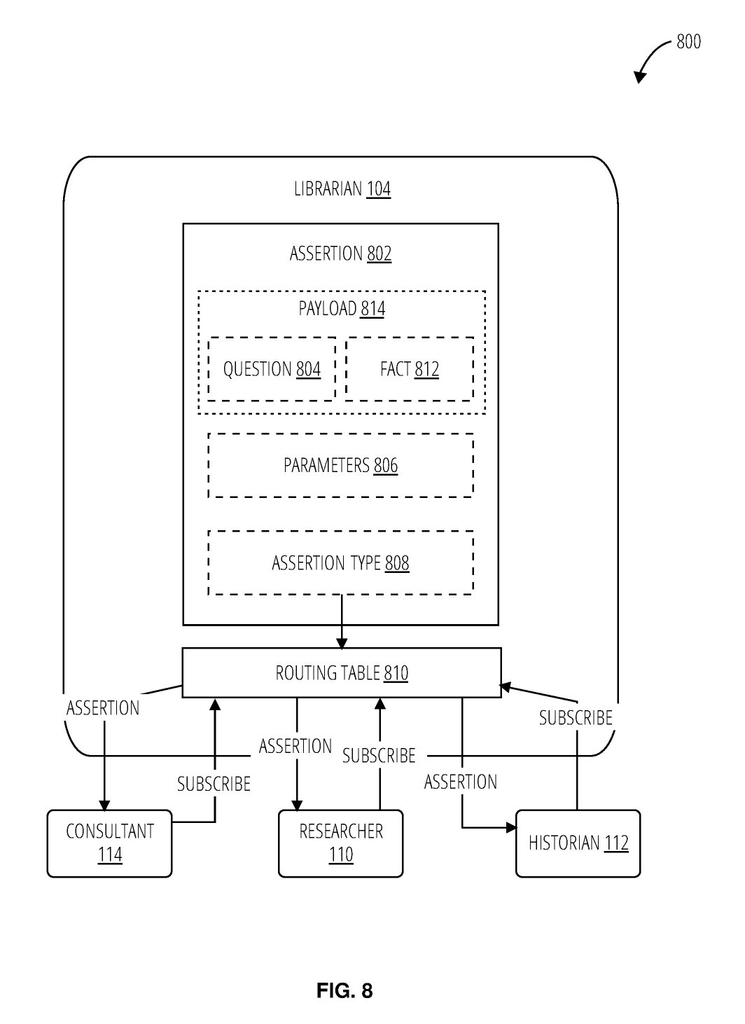

Referring to FIG. 8, the loosely-coupled system 800 comprises a librarian 104, a researcher 110, a historian 112, a consultant 114, an assertion 802, and a routing table 810. The assertion 802 further comprises a question 804, parameters 806, an assertion type 808, and a fact 812. The payload 814 further comprises the question 804 and the fact 812.

The routing table 810 may be configured manually by the user, by the librarian, or by external modules. The consultant 114 subscribes to a question type via the routing table 810. The researcher 110 subscribes to a question type via the routing table 810 the historian 112 subscribes to a question type via the routing table 810. The routing decisions may be made based on the assertion type 808. The routing table 810 routes the assertion 802 to the consultant 114 the researcher 110 or the historian 112 based on the assertion type 808 (identifier). For example, the consultant 114 may “subscribe” to the librarian to answer questions of a certain type. The assertion type 808 may identify whether the payload 814 in the assertion 802 is a fact 812 or a question 804. The parameters 806 (meta information about the question) may further inform the researcher 110, the consultant 114 and the historian 112 of additional information about the question 804 (query) when addressing (answering) the assertion 802.

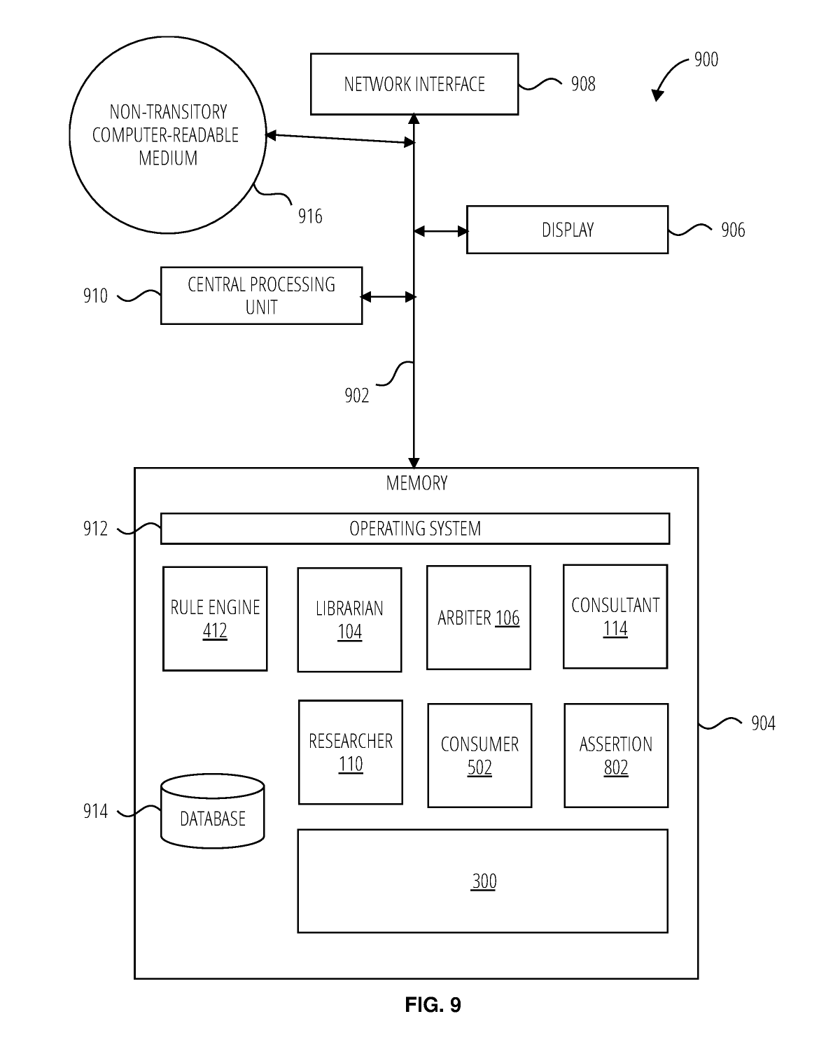

FIG. 9 illustrates several components of an exemplary system 900 in accordance with one embodiment. In various embodiments, system 900 may include a desktop PC, server, workstation, mobile phone, laptop, tablet, set-top box, appliance, or other computing apparatus or device that is capable of performing operations such as those described herein. In some embodiments, system 900 may include many more components than those shown in FIG. 9. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 900 may comprise one or more physical and/or logical devices that collectively provide the functionalities described herein. In some embodiments, system 900 may comprise one or more replicated and/or distributed physical or logical devices.

In some embodiments, system 900 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

System 900 includes a bus 902 interconnecting several components including a network interface 908, a display 906, a central processing unit 910, and a memory 904.

Memory 904 generally comprises a random access memory (“RAM”) and permanent non-transitory mass storage device, such as a hard disk drive or solid-state drive. Memory 904 stores an operating system 912.

These and other software components may be loaded into memory 904 of system 900 using a drive mechanism (not shown) associated with a non-transitory computer-readable medium 916, such as a DVD/CD-ROM drive, memory card, network download, or the like.

Memory 904 also includes database 914. In some embodiments, system 900 may communicate with database 914 via network interface 908, a storage area network (“SAN”), a high-speed serial bus, and/or via the other suitable communication technology.

In some embodiments, database 914 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

### Terminology and Interpretation

Terms used herein should be accorded their ordinary meaning in the relevant arts, or the meaning indicated by their use in context, but if an express definition is provided, that meaning controls.

“Arbiter” herein refers to logic to evaluate the quality of the data source, this may be evaluated as a cost function. For example: arbiter(first returned data, second returned data){ if(verbosity of data is specified as being beneficial){ return all data;} if(data is within relevancy tolerance value ){ /*where tolerance value may be for example, a measure of the similarity between the returned data and the requested data*/ return most relevant data;} if(data is similarly relevant){ return most recent data;} if(system cost is significantly higher to retrieve certain data){ return most efficient data;} }

“Assertion” herein refers to a fact, for example a data reading or calculated data, or a query for information.

“Business rule” herein refers to a business rule may be abstractions of the policies and practices of a business organization, generally inform the development of data rules.

“Consultant” herein refers to logic to draw from vertical domain-specific knowledge, built into the system (preconfigured); e.g. consultant(specialized data query){ return data from specialized source;}

“Consumer” herein refers to any logic which is an end point data consumer. This may take the form of a rule engine or a user interface.

“Data warehouse” herein refers to a control memory structure, for example a database.

“Historian” herein refers to logic to query historical records, for instance records stored in the data warehouse. May be employed as a traditional database management system.

“Librarian” herein refers to logic to map queries and assertions onto the appropriate (particularly associated with the queries or assertions) data source. For example (where an assertion may be a query or a fact): librarian(assertion){if(assertion requires immediate knowledge){ read sensor;} if(assertion is not immediate){ read historical data;} if(no permission to ask or assert){ return refusal;} }

“Researcher” herein refers to logic to aggregate and retrieve business logic researcher(businessLogic) businessLogic.addto(logicList) return results;} researcher(businessLogicQuery) businessLogic.getfrom(logicList) return results;}

“Circuitry” herein refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” herein refers to software logic embodied as processor-executable instructions stored in read-only memories or media.

“Hardware” herein refers to logic embodied as analog or digital circuitry.

“Logic” herein refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” herein refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

What is claimed is:

1. A method comprising:
configuring a librarian routing table in a computer network router to route a plurality of assertion types to a historian, a consultant, and a researcher;
wherein the historian is logic to query historical records stored in the data warehouse, the librarian is logic to map queries and assertions onto a particular data source, the researcher is logic to aggregate and retrieve business logic, and the consultant is logic to draw from preconfigured vertical domain-specific knowledge;
receiving via the computer network an assertion packet from a consumer;
parsing the assertion packet into a payload, parameters, and the assertion type, and configuring the librarian routing table with the assertion type to create a dynamic routing map to communicate the assertion to the researcher, the historian, or the consultant via the computer network;
retrieving a response from one of the historian, the consultant, or the researcher, if the assertion is a query; and
triggering a machine response to the assertion if the assertion is determined to be a fact.

2. The method of claim 1 wherein dynamically mapping the assertion further comprises querying an arbiter to choose data sources based on cost.

3. The method of claim 1 wherein the consequences further comprise persisting information to one of the historian, the consultant, or the researcher.

4. The method of claim 1 wherein the consequences further comprise operating of a machine-system.

5. The method of claim 1 wherein the researcher contains translations to business logic.

6. The method of claim 1 wherein the consultant may be vertical-specific knowledge built into a system.

7. The method of claim 1 wherein the historian further comprises a control memory structure and may pull simple queries from stored data.
